(19) United States
(12) Patent Application Publication
(10) Pub. No.: US 2025/0069877 A1
(43) Pub. Date: Feb. 27, 2025

(54) Method to Operate a Mass Spectrometer to Counteract Space Charge Effects

(71) Applicant: DH Technologies Development Pte. Ltd., Singapore (SG)

(72) Inventors: Mircea GUNA, Toronto (CA); William LOYD, Sugar Land, TX (US)

(73) Assignee: DH Technologies Development Pte. Ltd., Singapore (SG)

(21) Appl. No.: 18/718,871

(22) PCT Filed: Dec. 13, 2022
(86) PCT No.: PCT/IB2022/062146

§ 371 Date: Jun. 12, 2024

Related U.S. Application Data
(60) Provisional application No. 63/291,032, filed on Dec. 17, 2021.

(51) Int. Cl. H01J 49/06

(52) U.S. Cl. CPC H01J 49/063

(57) ABSTRACT

A method of performing mass spectrometry is disclosed. which comprises introducing a plurality of ions into an ion guide of a mass spectrometer via an inlet orifice thereof. where the ion guide includes a plurality of rods arranged in a multipole configuration and spaced from one another to provide a passageway for transit of the ions therethrough. applying RF voltages to the rods so as to generate an electromagnetic field within the passageway for providing radial confinement of the ions passing through the passageway, identifying a space charge effect, which can adversely affect operation of the mass spectrometer, based on detection of a variation of an intensity of an ion detection signal associated with at least one ion population transmitted through said ion guide and having an m/z ratio greater than a threshold, and in response to said identification of the adverse space charge effect. adjusting at least one of frequency and amplitude of the RF voltages to counteract said space charge effect.

### TECHNICAL FIELD

The present disclosure relates to systems and methods for use in mass spectrometry in which space charge effects that can adversely affect the performance of a mass spectrometer can be detected and reduced.

### BACKGROUND

The present teachings are generally related to methods and systems for performing mass spectrometry, and more particularly, to such methods and systems that can counteract the space charge effects that may adversely affect the performance of a mass spectrometer.

Mass spectrometry (MS) is an analytical technique for determining the structure of test chemical substances with both qualitative and quantitative applications. MS can be useful for identifying unknown compounds, determining the composition of atomic elements in a molecule, determining the structure of a compound by observing its fragmentation, and quantifying the amount of a particular chemical compound in a mixed sample. Mass spectrometers detect chemical entities as ions such that a conversion of the analytes to charged ions must occur during the sampling process.

There is a need for methods and systems for operating a mass spectrometer, which can ameliorate adverse effects of space charge, for example, when the mass spectrometer is operated at high ion input rates.

### SUMMARY

In one aspect, a method of performing mass spectrometry is disclosed, which comprises introducing a plurality of ions into an ion guide of a mass spectrometer via an inlet orifice thereof, where the ion guide includes a plurality of rods arranged in a multipole configuration and spaced from one another to provide a passageway for transit of the ions therethrough, applying RF voltages to the rods so as to generate an electromagnetic field within the passageway for providing radial confinement of the ions passing through the passageway, identifying a space charge effect, which can adversely affect operation of the mass spectrometer, based on detection of a variation of an intensity of an ion detection signal associated with at least one ion population transmitted through said ion guide and having an m/z ratio greater than a threshold, and in response to said identification of the adverse space charge effect, adjusting at least one of frequency and amplitude of the RF voltages to counteract said space charge effect.

In some embodiments, the space charge effect can be adjusted via adjusting the flux of ions entering the inlet orifice associated with said at least one ion population having said m/z ratio above the threshold and identifying said adverse space charge effect based on observing a change indicative of said space charge effect in the intensity of said at least one ion detection signal at two or more ion fluxes.

In some embodiments, the change in said at least one ion detection signal indicative of the adverse space charge effect corresponds to a decrease in the intensity of the ion detection signal in response to an increase in the ion flux. In some embodiments, the change in said at least one ion detection signal indicative of the adverse space charge effect corresponds to an increase in the intensity of the ion detection signal in response to a decrease in ion flux.

In some embodiments, the step of identifying the adverse space charge effect comprises comparing the intensity of the ion detection signal with an expected intensity for said ion detection signal.

In some embodiments, the step of identifying the adverse space charge effect comprises detecting a lower intensity for said at least one ion detection signal relative to the expected intensity.

In some embodiments, the step of adjusting the ion flux comprises changing a concentration of at least one ingredient in a sample ionized to generate said plurality of ions.

In some embodiments, the step of adjusting the ion flux comprises changing an ionization voltage utilized to generate said plurality of ions.

In some embodiments, the step of identifying the space charge effect comprises comparing the intensity of the ion detection signal associated with the ion population having an m/z ratio greater than the threshold with an intensity of an ion detection signal associated with an ion population having an m/z ratio less than the threshold.

In some embodiments, the threshold can be any of about 1 kDa, about 2 kDa, about 3 kDa, or any other threshold suitable for a particular application.

In some embodiments, the step of adjusting the at least one of said RF frequency and said RF voltage amplitude comprises reducing the RF frequency.

In some embodiments, the step of adjusting the at least one of said RF frequency and said RF voltage amplitude comprises increasing the RF voltage amplitude.

In some embodiments, the inlet orifice can have a diameter equal to or greater than about 0.6 mm, e.g., in a range of about 0.6 mm to about 2 mm, such as 1.5 mm.

In some embodiments, the ion guide can be positioned in an evacuated chamber maintained at a pressure in a range of about 1 Torr to about 4 Torr, e.g., in a range of about 2

Torr to about 4 Torr.

In some embodiments, the plurality of ions can be transmitted through another ion guide positioned upstream of said ion guide and in an upstream evacuated chamber that is maintained at a pressure greater than the pressure of said evacuated chamber. By way of example, the upstream evacuated chamber can be maintained at a pressure in a range of about 4 Torr to about 10 Torr, e.g., in a range of about 4 Torr to about 6 Torr.

In some embodiments, the plurality of ions can be transmitted through yet another ion guide positioned downstream of said ion guide and in a downstream evacuated chamber that is maintained at a pressure lower than the pressure of said evacuated chamber. By way of example, the downstream evacuated chamber can be maintained at a pressure below 100 mTorr, e.g., in a range of about 2 mTorr to about 20 mTorr.

In some embodiments, the step of adjusting the ion flux comprises changing the RF voltage applied on the upstream ion guide utilized to transmit said plurality of ions.

In a related aspect, a method of performing mass spectrometry is disclosed, which comprises introducing a sample into an ion source to cause ionization of at least a portion thereof so as to generate a plurality of ions, wherein at least a portion of said ions have an m/z ratio greater than a threshold, introducing the plurality of ions into an ion guide of a mass spectrometer via an inlet orifice thereof, wherein said ion guide comprises a plurality of rods arranged in a multipole configuration and spaced from one another to provide a passageway for transit of the ions therethrough, applying RF voltages at a first RF frequency and a first RF voltage amplitude to said rods so as to generate an electromagnetic field within said passageway for providing radial confinement of the ions passing through the passageway, identifying an adverse space charge effect based on a comparison of an intensity of at least one ion detection signal associated with at least one of said ions having an m/z ratio above the threshold with a reference intensity, and in response to identification of the adverse space charge effect, adjusting at least one of said RF frequency, said RF voltage amplitude, and a flux of ions introduced into said ion guide so as to counteract said adverse space charge effect.

In some embodiments of the above method, the step of identifying the adverse space charge effect comprises detecting a lower intensity for said at least one ion detection signal relative to said reference intensity.

In some embodiments, the reference intensity corresponds to an intensity of a respective ion detection signal associated with at least one ion population having an m/z ratio less than said threshold.

In some embodiments, the step of adjusting the RF frequency comprises reducing the RF frequency.

In some embodiments, the step of adjusting the RF voltage amplitude comprises increasing the RF voltage amplitude.

In some embodiments, the threshold can be any of about 1 kDa, about 2 kDa, about 3 kDa, or any suitable threshold for a particular application.

In some embodiments, the step of adjusting at least one of the RF frequency and the RF voltage amplitude comprises reducing said RF frequency.

In some embodiments, the step of adjusting at least one of the RF frequency and the RF voltage amplitude comprises increasing said RF voltage amplitude.

In some embodiments, the ion source can be an atmospheric electrospray ion source and said step of adjusting the ion flux comprises adjusting an ion spray voltage of the electrospray ion source.

In some embodiments, the step of adjusting the flux of ions introduced into the ion guide comprises adjusting RF voltages applied to the rods of a multipole ion guide positioned upstream of said ion guide.

In some embodiments, the step of adjusting the flux of ions introduced into the ion guide comprises adjusting a DC voltage applied to an ion lens positioned between said ion guide and the upstream ion guide.

In a related aspect, a mass spectrometer is disclosed, which comprises an ion source configured to receive a sample and to ionize at least a portion of the sample to generate a plurality of ions, an ion guide positioned downstream of the ion source, said ion guide comprising a plurality of rods arranged in a multipole configuration and configured for application of RF voltages thereto to provide radial confinement of the ions as the ions pass through the ion guide. The mass spectrometer further includes an ion detector positioned downstream of the ion guide and configured to receive the ions transmitted through the ion guide and/or one or more fragments thereof generated downstream of the ion guide and to generate one or more ion detection signals. An analysis module is in communication with the ion detector and configured to receive the one or more ion detection signals and to determine a transmission rate of the ions having m/z ratios above a threshold through said ion guide, wherein the analysis module is configured to identify an adverse space charge effect on transmission of the ions having m/z ratios above the threshold through the ion guide based on a comparison of said determined transmission rate with a reference transmission rate.

In some embodiments, another ion guide is positioned upstream of said ion guide. In some such embodiments, said upstream ion guide and said ion guide are positioned within a first and a second evacuated chamber, respectively. In some embodiments, yet another ion guide is positioned downstream of said ion guide. In some such embodiments, said downstream ion guide is positioned within a third evacuated chamber.

In some such embodiments, the first evacuated chamber is maintained at a pressure higher than a pressure at which the second evacuated chamber is maintained. In some embodiments, the third evacuated chamber is maintained at a pressure lower than the pressure at which the second evacuated chamber is maintained. For example, the first evacuated chamber can be maintained at a pressure in a range of about 4 Torr to about 6 Torr, the second evacuated chamber can be maintained at a pressure in a range of about 2 Torr to about 4 Torr, and the third evacuated chamber can be maintained at a pressure in a range of about 2 mTorr to about 20mTorr.

In some embodiments, the threshold can be about 1 kDa, about 2 kDa, about 3 kDa, or any other threshold suitable for a particular application.

A variety of ion sources can be used in the practice of the present teachings. By way of example, the ion source can be an atmospheric spray ion source. In some such embodiments, the ionization voltage of such an atmospheric spray ion source can be adjusted to adjust the ion flux entering the ion guide in order to ameliorate a detected adverse space charge effect.

Further understanding of various aspects of the present teachings can be obtained by reference to the following detailed description in conjunction with the associated drawings, which are described briefly below.

### BRIEF DESCRIPTION OF THE DRAWINGS

FIG. 1A presents MS/MS TOF spectra of 1e⁻⁴ pmol/μl of PPG (polypropyl glycol) obtained for RF frequencies of 1.6 MHz applied to a QJet® ion guide of a triple quadrupole mass spectrometer;

FIG. 1B presents MS/MS TOF spectra of 1e⁻⁴ pmol/μl of PPG (polypropyl glycol) obtained for RF frequencies of 0.5 MHz applied to a QJet® ion guide of a triple quadrupole mass spectrometer;

FIG. 2 presents XIC (extracting ion count) for ions having an m/z of 2706 as a function of QJet® RF voltage for concentrations of the PPG solution 2e⁻⁷ pmol/μl, 2e⁻⁶ pmol/μl, and 1e⁻⁴ pmol/μl;

FIG. 3 is a flow chart showing a method for performing mass spectrometry according to embodiments of the present teachings;

FIG. 4A schematically depicts a mass spectrometer system according to embodiments of the present teachings;

FIG. 4B schematically depicts a mass spectrometer system according to another embodiment of the present teachings;

FIGS. 5A-5D show the ion transmission performance of the mass spectrometer with the QJet® operating at a high RF frequency (i.e., 1.6 MHz);

FIGS. 6A-6C show the ion transmission performance of the mass spectrometer with the QJet® operating at a low RF frequency (i.e., 0.5 MHz) and with an ion source voltage of 5500 V; and

FIGS. 7A-7C show the ion transmission performance of the mass spectrometer with the QJet® operating at a low RF frequency (i.e., 0.5 MHz) and with an ion source voltage of 3000 V.

### DETAILED DESCRIPTION

It will be appreciated that for clarity, the following discussion will explicate various aspects of embodiments of the present disclosure, while omitting certain specific details wherever convenient or appropriate to do so. For example, discussion of like or analogous features in alternative embodiments may be somewhat abbreviated. Well-known ideas or concepts may also for brevity not be discussed an any great detail. One of ordinary skill will recognize that some embodiments of the present disclosure may not require certain of the specifically described details in every implementation, which are set forth herein only to provide a thorough understanding of the embodiments. Similarly it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and, “substantially, and “substantially equal” refer to variations in a numerical quantity and/or a complete state or condition that can occur, for example, through measuring or handling procedures in the real world; through inadvertent error in these procedures; through differences in the manufacture, source, or purity of compositions or reagents; and the like. Typically, the terms “about” and “substantially” as used herein mean 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

Various terms are used herein in accordance with their ordinary meanings in the art. For example, the term “adverse space charge effect” refers to a charge effect that can affect the operation of a mass spectrometer in an undesired manner, e.g., by changing the intensity of a mass peak in a way that is opposite to that expected in absence of the adverse space charge effect. As another example, the term “mass ion filter” and “ion filter” are used herein interchangeably to refer to a structure that can be employed, for example, in a mass spectrometer, for limiting the transmission of ions to those having a target m/z ratio or an m/z ratio within a target range.

The present teachings are generally related to methods and systems for performing mass spectrometry. In a mass spectrometer, an ion source is employed to ionize a sample so as to generate a plurality of ions. Mass spectrometers typically employ ion guides that receive the ions from the ion source via an upstream inlet orifice of the mass spectrometer and form an ion beam that can be received by the downstream components of the mass spectrometer.

Increasing the size of the inlet orifice between an ion source and a downstream ion guide in a mass spectrometer can increase the number of ions entering the ion guide thereby increasing the sensitivity of a mass analysis performed by the mass spectrometer. However, in intense ion beams, Coulomb interactions between the ions present in the ion beam forces the larger m/z ions toward larger radial positions in the ion guide since the effective potential, at a specific RF voltage, is lower for larger m/z ions than for the lower m/z ions.

If the Coulomb forces exceed the electrodynamic force of the electric field, ions can hit the ion guide rods and even if they do exit the ion guide, their radial amplitudes will be so large such that they will hit the rods of a downstream ion guide and/or a mass analyzer.

An estimate of the charge capacity of an RF quadrupole ion guide can be determined by equilibrium condition between the space charge Coulomb repulsion field (E_{Coul}) and the effective RF focusing field (E_{RF}), as expressed in Eqn (1):

$${E}_{C o u l} = - {E}_{R F} \qquad ( 1 )$$

In turn, the effective RF focusing field (ERF) is defined as the gradient of the effective potential (U_{RF}) which is defined by Eqn (2):

$${U}_{R F} = γ \frac{{( r / R )}^{2} {V}_{R F}^{2}}{( m / q ) {R}^{2} {ω}^{2}} \qquad ( 2 )$$

where V_{RF} is the amplitude of the RF voltage applied to the quadrupole rod (pole to ground); ω is the angular frequency (ω=2πf); m is the ion mass; q=ze where z is the ion's charge and e is the elementary charge; R is the inscribed radius of the quadrupole; r is the radial coordinate; and the y coefficient takes into account the influence of the gas on the ion motion.

Accordingly, the effect of the RF focusing field (E_{RF}) can be expressed as Eqn (3):

$${E}_{R F} = - γ \frac{2 ( r / R ) {V}_{R F}^{2}}{( m / z ) {R}^{3} {ω}^{2}} \qquad ( 3 )$$

Eqns (1)-(3) show that higher transmission losses are expected for ions that have large m/z ratios due to the space charge interaction since the focusing RF field is less strong for ions having the large m/z ratios. Additionally, the confinement would be stronger at lower frequencies than at higher frequencies, and for a specific RF frequency, it would increase with the RF voltage.

For example, when operating a research grade X500 B Sciex instrument having a QJet® ion guide in the DJet®/QJet® configuration at two different frequencies of 1.6 MHz and 0.5 MHz, which were chosen, respectively, for better transmission of ions of m/z<2 kDa and better transmission of ions of m/z>4 kDa (the effective potential at 0.5 MHz is about (1.6/0.5)² =10.24 larger that at 1.6 MHz not considering higher order fields), it was observed that at a large ion population, the transmission of ions having an m/z>1 kDa was significantly higher when the QJet® was operated at the low frequency than when the QJet® was operated at the high frequency, with the RF voltage set at maximum RF voltage of 300 Vₚ₋ₚ.

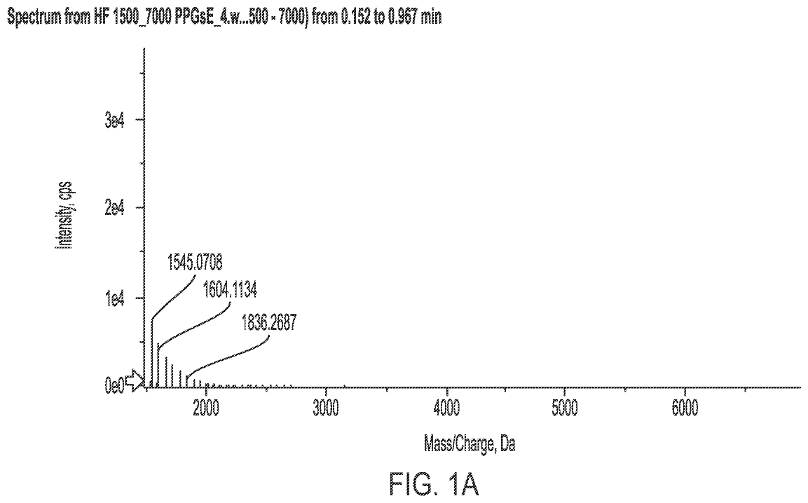

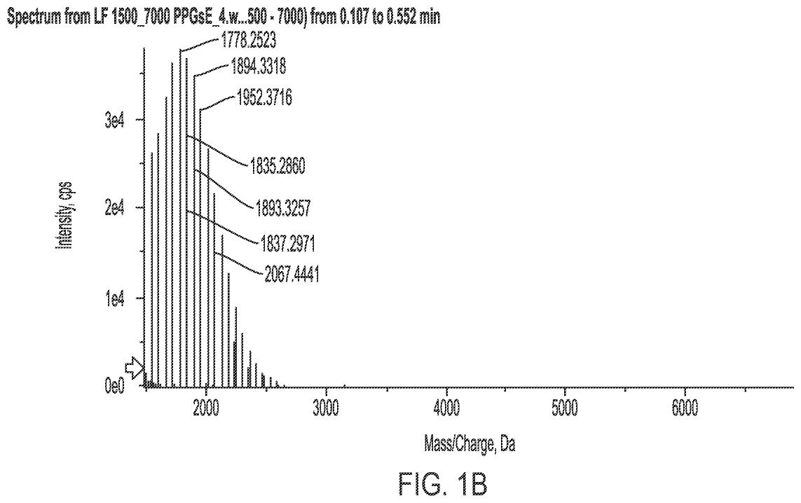

For example, FIG. 1A presents MS/MS TOF spectra of 1e⁻⁴ pmol/μl of PPG (polypropyl glycol) obtained for RF frequencies of 1.6 MHz, and FIG. 1B presents MS/MS TOF spectra of 1e⁻⁴ pmol/μl of PPG obtained for RF frequencies of 0.5 MHz applied to the QJet®. These spectra show a much higher transmission of ions with m/z>1 kDa at the lower RF frequency of 0.5 MHz.

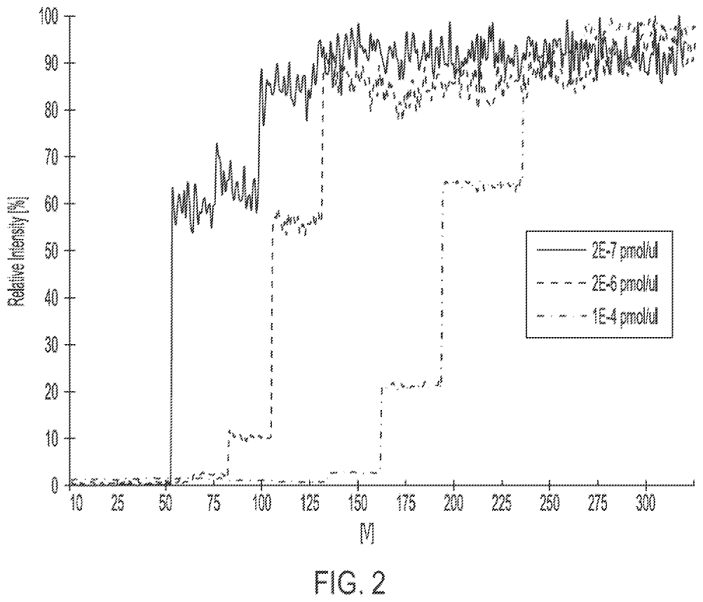

Further, FIG. 2 presents XIC (extracting ion count) for ions having an m/z of 2706 as a function of the amplitude of the QJet® RF voltage for three different concentrations of the PPG solution, namely, 2e⁻⁷ pmol/μl , 2e⁻⁶ pmol/μl , and 1e⁻⁴ pmol/μl . FIG. 2 shows that when a higher concentration of the PPG solution is used, the optimal RF voltage amplitude for higher ion transmission is increased to 300 Vₚ₋ₚ. The RF voltage was varied every 0.5 minute, and the traces were recorded at different times and overlaid.

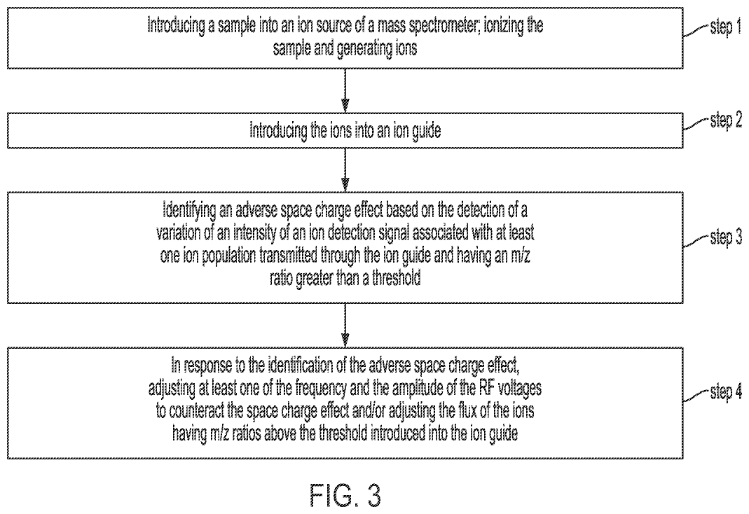

With reference to the flow chart of FIG. 3, in one embodiment of a method according to the present teachings for performing mass spectrometry, a sample is introduced into an ion source of a mass spectrometer so as to ionize at least a portion of the sample to generate a plurality of ions (step 1). The ions are introduced into an ion guide positioned downstream of the ion source via an inlet orifice thereof (step 2). In some embodiments, the ion guide includes a plurality of rods arranged in a multipole configuration and spaced from one another to provide a passageway for transit of the ions therethrough, where RF voltages can be applied to the rods so as to generate an electromagnetic field within the passageway for providing radial confinement of the ions passing through the passageway. An adverse space charge effect can be identified based on the detection of a variation of an intensity of an ion detection signal associated with at least one ion population transmitted through the ion guide and having an m/z ratio greater than a threshold (step 3). In response to the identification of the adverse space charge effect, at least one of the frequency and the amplitude of the RF voltages can be adjusted to counteract the space charge effect (step 4).

In some embodiments, the space charge effect can be identified by adjusting the flux of the ions having m/z ratios above the threshold introduced into the ion guide via its inlet orifice based on observing a change indicative of the adverse space charge effect in the intensity of the ion detection signal at a plurality of different ion fluxes.

By way of example, the detection of a decrease in the intensity of the ion detection signal in response to an increase in the ion flux can indicate an adverse space charge effect. By way of another example, the detection of an increase in the intensity of the ion detection signal in response to a decrease in the ion flux can indicate an adverse space charge effect.

In some embodiments, the step of identifying the adverse space charge effect comprises comparing the intensity of the ion detection signal with an expected intensity for the ion detection signal.

In some embodiments, once the adverse space charge effect is detected, at least one of the frequency and the amplitude of the RF voltages applied to the rods of the ion guide can be adjusted to reduce, and preferably eliminate, the adverse space charge effect. By way of example, in some such embodiments, the RF frequency can be reduced to ameliorate the adverse space charge effect. In some such embodiments, the reduction of the RF frequency can be accomplished in multiple stages. For example, the RF frequency can be initially reduced by 10% and the ion detection intensity can be monitored to determine if the adverse space charge effect has been resolved. If not, the RF frequency may be reduced by another 10% and the process can be iterated until an acceptable result is achieved.

In some embodiments, to reduce, and preferably eliminate, a detected adverse space charge effect, the amplitude of the RF voltages applied to the rods of the ion guide can be increased. Similar to the RF frequency adjustment, the amplitude of the RF voltages applied to the rods of the ion guide can be adjusted in stages until the adverse space charge effect is sufficiently reduced, and preferably eliminated.

In some embodiments, the ion detection signal monitored to detect an adverse space charge effect can be an ion detection signal associated with ions having an m/z ratio greater than about 1 kDa, or about 2 kDa, or about 3 kDa, or about 4 kDa, or any other threshold suitable for a particular application.

As noted above, the ions generated by the ion source can be introduced into the ion guide via the inlet orifice thereof. In some embodiments, the inlet orifice can be substantially circular with a diameter that is equal to or greater than about 0.6 mm, e.g., about 1.5 mm. A larger diameter can allow receiving an ion beam at a higher intensity. The present teachings allow adjusting the intensity of the ion beam in a manner discussed herein to reduce, and preferably eliminate, adverse space charge effects. By way of example, a voltage for driving the ion source can be controlled to adjust the intensity of the ion beam, thereby reducing, and preferably eliminating, a detected adverse space charge effect.

As noted above, in some embodiments, another ion guide (e.g., downstream ion guide, such as Q0 ion guide described below) can be positioned downstream of the above-described ion guide (e.g., QJet® ion guide). By way of example, the ion guides can be positioned in separate evacuated chambers where the chamber in which the downstream ion guide is positioned is maintained at a pressure lower than a pressure at which the guide is maintained. For example, the pressure of the evacuated chamber in which the downstream ion guide is positioned can be in the 2-20 mTorr range, e.g., at about 5 mTorr, while the pressure of the evacuated chamber in which the ion guide is maintained can be in the 2-4 Torr range, e.g., at about 2 Torr.

In some embodiments, the variation of an ion detection signal for an ion having an m/z ratio above a threshold (e.g., above about 1 kDa) as a function of a change in ion flux entering the mass spectrometer can be compared with that of a respective ion detection signal associated with an ion population having an m/z ratio below the threshold for detecting an adverse space charge effect. By way of example, an adverse space charge effect may be identified when an increase in the ion flux results in an increase in the intensity of the ion detection signal associated with an ion population having a lower m/z ratio and a decrease in the intensity of the ion detection signal associated with an ion population having an m/z ratio above the threshold.

The present teachings for detecting adverse space charge effects when operating a mass spectrometer and modifying one or more operating parameters of the mass spectrometer to reduce, and preferably eliminate, the adverse space charge effects can be utilized in a variety of different mass spectrometers.

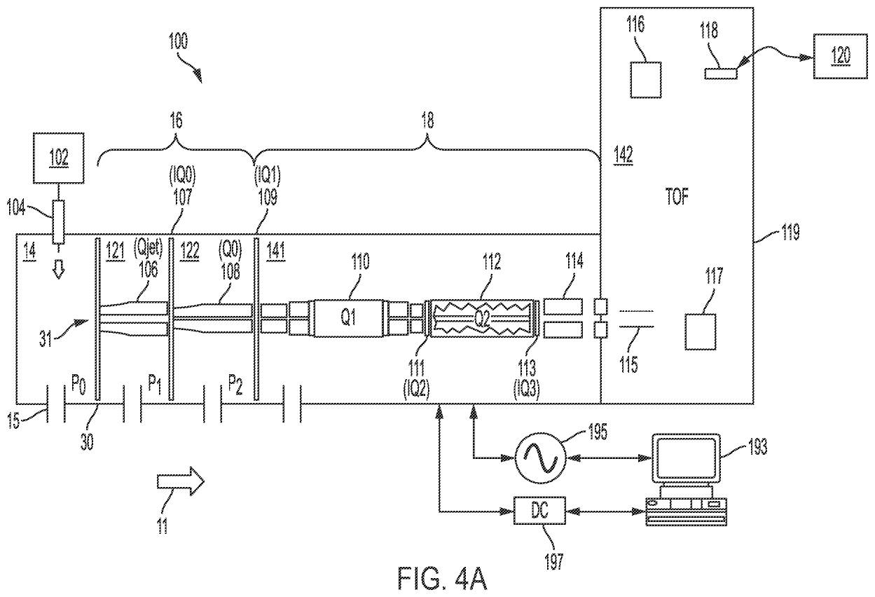

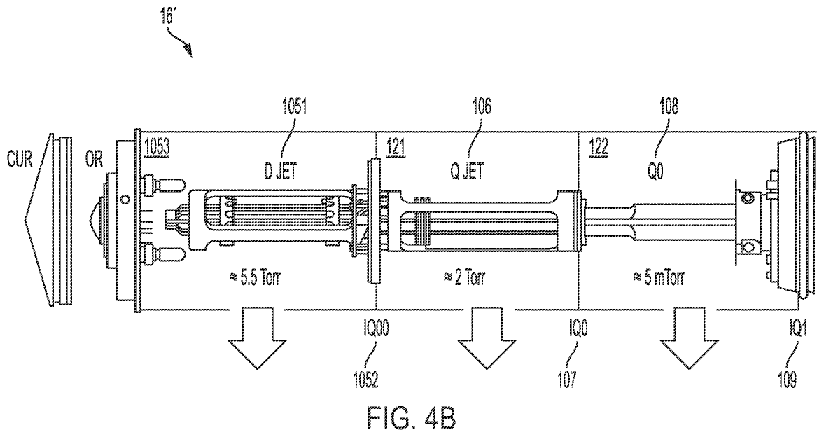

By way of example, FIG. 4A schematically depicts such a mass spectrometer system 100 in accordance with various aspects of the present teachings in which the space charge effects, e.g., due to high intensity ion beams, can be detected and controlled in a manner discussed herein. As shown, the exemplary mass spectrometer system 100 can include an ion source 104 for generating ions within an ionization chamber 14, an upstream section 16, and a downstream section 18.

The upstream section 16 is configured to perform initial processing of ions received from the ion source 104, and includes various elements such as a curtain plate 30 and one or more high pressure (Torr range) ion guides 106 (e.g., QJet® ion guide), and one or more lower pressure (mTorr) ion guide 108 (e.g., Q0 ion guide). The downstream section 18 includes a mass analyzers (Q1) 110, a collision cell (Q2) 112, ion transfer optics 114, and a TOF mass analyzer 119. A controller 193, which is operably connected to one or more power supplies 195, 197, can control the RF signal applied to the ion guides 106 and 108.

The ion source 104 can be any known or hereafter developed ion source for generating ions and modified in accordance with the present teachings. Non-limiting examples of ion sources suitable for use with the present teachings include atmospheric pressure chemical ionization (APCI) sources, electrospray ionization (ESI) sources, continuous ion sources, a pulsed ion source, a matrix-assisted laser desorption/ionization (MALDI) ion source, an electron impact ion source, a chemical ionization source, or a photo-ionization ion source, among others.

The system 100 can also include a sample source 102 configured to provide a sample to the ion source 104. The sample source 102 can be any suitable sample inlet system known in the art. By way of example, the ion source 104 can be configured to receive a fluid sample (typically a liquid sample) from a variety of sample sources, including a reservoir containing a fluid sample that is delivered to the sample source (e.g., pumped), a liquid chromatography (LC) column, a capillary electrophoresis device, and via an injection of a sample into a carrier liquid. In the example depicted in FIG. 4A, the ion source 104 comprises an electrospray electrode, which can comprise a capillary fluidly coupled to the sample source 102 (e.g., through one or more conduits, channels, tubing, pipes, capillary tubes, etc.), and which terminates in an outlet end that at least partially extends into the ionization chamber 14 to discharge the liquid sample therein.

One or more power supplies can supply electrical power to the ion source 104 with appropriate voltages for ionizing the analytes in either positive ion mode (analytes in the sample are protonated, generally forming the cations to be analyzed) or negative ion mode (analytes in the sample are deprotonated, generally forming the anions to be analyzed). As shown, for example, the system 100 includes an RF power supply 195 and a DC power supply 197 that can be controlled by a controller 193 so as to apply electric potentials having RF, AC, and/or DC components to the various components of the system 100. Further, the ion source 104 can be nebulizer-assisted or non-nebulizer assisted. In some embodiments, ionization can also be promoted with the use of a heater, for example, to heat the ionization chamber so as to promote dissolution of the liquid discharged from the ion source.

With continued reference to FIG. 4A, at least a portion of the analytes contained within the sample discharged from the ion source 104, can be ionized within the ionization chamber 14, which is separated from the upstream section 16 by the curtain plate 30. The curtain plate 30 can define a curtain plate aperture 31, which is in fluid communication with the upstream section 16. Although not shown in FIG. 4A, the system 100 can include various other components. For example, the system 100 can include a curtain gas supply (not shown) that provides a curtain gas flow (e.g., of N₂) to the upstream section 16 of the system 100. The curtain gas flow can aid in keeping the downstream section 18 of the mass spectrometer system 100 clean (e.g., by de-clustering and evacuating large neutral particles). For example, a portion of the curtain gas can flow out of the curtain plate aperture 31 into the ionization chamber 14, thereby preventing the entry of droplets and/or neutral molecules through the curtain plate aperture 31.

In this embodiment, the ionization chamber 14 can be maintained at a pressure P₀, which can be atmospheric pressure or a substantially atmospheric pressure. However, in some embodiments, the ionization chamber 14 can be evacuated to a pressure lower than atmospheric pressure. The ions generated by the ion source 104 generally travel towards the vacuum chambers 121, 122, 141, and 142 in the direction indicated by the arrow 11 in FIG. 4A.

Initially, these ions can be successively transmitted through the elements of the upstream section 16 (e.g., curtain plate 30, ion guide 106, and ion guide 108) to result in a narrow and highly focused ion beam (e.g., along the central longitudinal axis of the system 100) for further m/z-based analysis within the downstream portion 18. The ions generated by the ion source 104 enter the upstream section 16 to traverse one or more intermediate vacuum chambers 121, 122 and/or ion guides 106 and 108 having elevated pressures greater than the high vacuum chamber 141 within which the mass analyzers are disposed. The vacuum chamber 121 can be maintained at a pressure (P1) ranging from approximately 500 mTorr to approximately 5 Torr, although other pressures can be used for this or for other purposes. In certain implementations, the vacuum chamber 121 can be maintained at a pressure in a range from about 2 Torr to about 15 Torr. Similarly, the downstream vacuum chamber 122 can be evacuated to a pressure (P2) that is lower than that of the vacuum chamber 121 (i.e., P₁). For example, the downstream vacuum chamber 122 can be maintained at a pressure of about 2 to 15 mTorr, although other pressures can be used for this or for other purposes.

The ion guide 106 can be an RF ion guide comprising, for example, a quadrupole rod set configured to provide not only collisional cooling of the ions but also their radial confinement. The ion guide 106 transfers the ions to subsequent ion optics such as the ion guide 108 (also referenced herein as “Q0”) through an ion lens 107 (also referenced herein as “IQ0”). The ions can be transmitted from the ion guide 106 through an exit aperture in the ion lens 107. The ion guide Q0 108 can be an RF ion guide and can comprise a quadrupole rod set. This ion guide Q0 108 can be positioned in the downstream vacuum chamber 122 so as to transport ions through an intermediate pressure region prior to delivering ions through the subsequent optics (e.g., IQ1 lens 109) to the downstream section 18 of system 100.

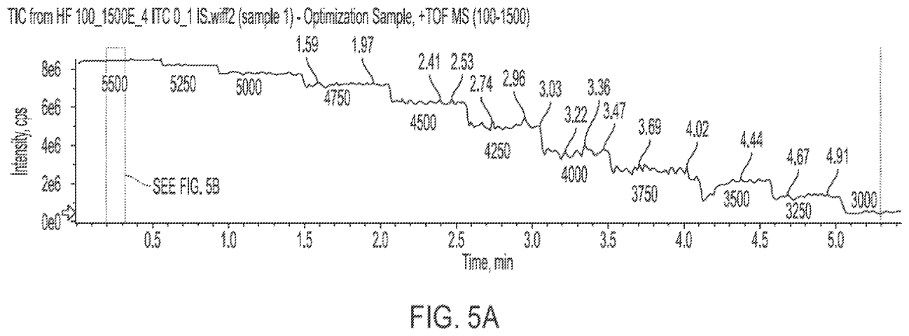

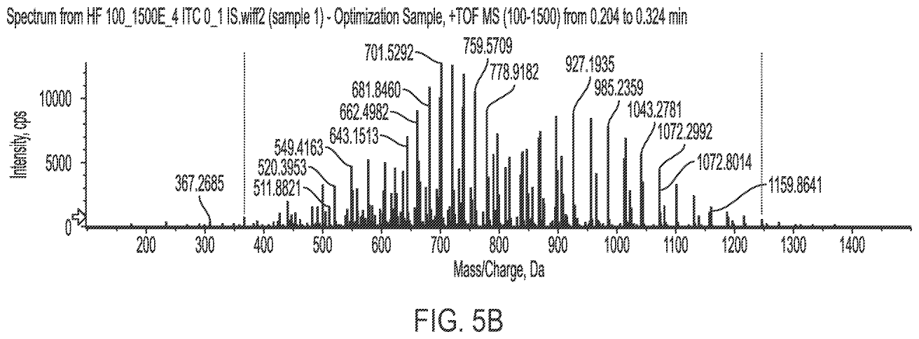

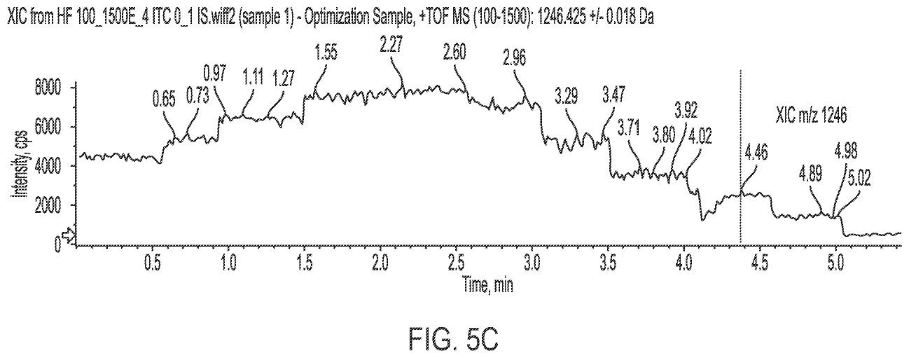

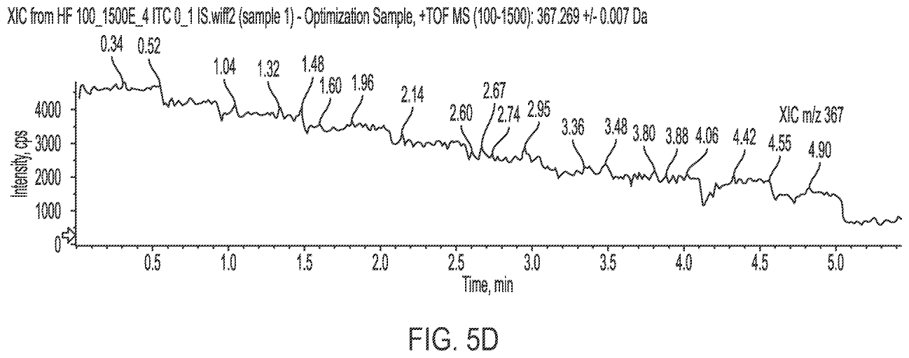

Ions passing through the quadrupole rod set Q0 108 pass through the lens IQ1 109 and into the adjacent quadrupole rod set Q1 110 in the downstream section 18. After being transmitted from Q0 108 through the exit aperture of the lens IQ1 109, the ions can enter the adjacent quadrupole rod set Q1 110, which can be situated in a vacuum chamber 141, which can be evacuated to a pressure maintained lower than that of the ion guide QJet® 106 chamber 121 and the ion guide Q20 108 chamber 122. For example, the vacuum chamber 141 can be maintained at a pressure less than about 1×10⁻⁴ Torr or lower (e.g., about 2×10⁻⁵ Torr), though other pressures can be used for this or for other purposes. As will be appreciated by a person of skill in the art, the quadrupole rod set Q1 110 can be operated as a conventional transmission RF/DC quadrupole mass filter to select a population of ions of interest (e.g., a population of ions having an m/z. ratio) and/or a range of ions of interest. For example, the quadrupole rod set Q1 110 can be provided with RF/DC voltages suitable for operation in a mass-resolving mode (e.g., by one or more voltage supplies 195, 197). As should be appreciated, taking the physical and electrical properties of mass analyzer Q1 110 into account, parameters for an applied RF and DC voltage can be selected so that Q1 110 establishes a transmission window of chosen m/z ratios, such that these ions can traverse Q1 110 largely unperturbed. Ions having m/z ratios falling outside the window, however, do not attain stable trajectories within the quadrupole and can be prevented from traversing the quadrupole rod set Q1 110. It should be appreciated that this mode of operation is but one possible mode of operation for Q1 110. Data shown in FIGS. 5-7 were acquired with the Q1 110 used in RF-only transmission mode, e.g. no resolving DC mode applied besides the 2 V DC attractive rod offset relative to the Q0 118 rods offset.

Ions passing through the quadrupole rod set Q1 110 can pass through the lens IQ2 111 and into the adjacent quadrupole rod set Q2 112, which as shown can be disposed in a pressurized compartment and can be configured to operate as a collision cell at a pressure approximately in the range of from about 1 mTorr to about 10 mTorr, though other pressures can be used for this or for other purposes. A suitable collision gas (e.g., nitrogen, argon, helium, etc.) can be provided by way of a gas inlet (not shown) to thermalize and/or fragment ions in the ion beam. By way of example, in MS/MS, the quadrupole rod set Q1 110 can be operated to transmit to Q2 112 precursor ions exhibiting a selected range of m/z ratios for fragmentation into product ions within Q2 112. In MS mode, the parameters for RF and DC voltages applied to the rods of Q2 112 can be selected so that Q2 transmits these ions therethrough largely unperturbed. Ions that are transmitted by quadrupole rod set Q2 112 can pass through the adjacent TOF transfer optics 114 into the extraction region of the TOF accelerator. Subsequently, ions are pulsed into the TOF analyzer 119 via a pusher electrode 115, which applies voltages to redirect the ions such that they travel between electrostatic mirrors 116, 117 and finally reach the detector 118. As will be appreciated by a person skilled in the art, the TOF analyzer is operated at a decreased operating pressure relative to that of the Q1 analyzer, for example, less than about 2×10⁻⁶ Torr (e.g., about 2×10⁻⁷ Torr).

Although, for convenience, the mass analyzers 110, 114 and collision cell 112 are described herein as having quadrupoles with elongated rod sets (e.g., having four rods), a person of ordinary skill in the art should appreciate that these elements can have other suitable configurations. It will also be appreciated that the one or more mass analyzers 110, 114 can be any of triple quadrupoles, linear ion traps, quadrupole time of flights, Orbitrap or other Fourier transform mass spectrometers, all by way of non-limiting examples.

In this embodiment, an analysis module 120 can receive a plurality of ion detection signals generated by the detector 118 and operate on those signals so as to generate a mass spectrum of the detected ions.

In some embodiments, in order to ensure that space charge effects will not adversely interfere with collection and analysis of mass data, the mass spectrometer 100 can be employed to acquire ion mass detection signals associated with an ion population having an m/z ratio above a threshold (e.g., an m/z ratio greater than about 1 kDa) at a variety of ion fluxes. For example, the controller 193 can be employed to adjust the ionization voltage utilized in the ion source to change the flux of ions entering into the mass spectrometer. The analysis module 120 can be configured to monitor the intensity of the ion detection signal as a function of the ion flux and to detect an adverse space charge effect via detection of an anomalous variation of the intensity of the ion detection signal as a function of a change in the ion flux. For example, the analysis module 120 can detect an adverse space charge effect when an increase in the ion flux, e.g., due to an increase in the ionization voltage applied to a sample in an ion source, results in a decrease in the intensity of the ion detection signal. Upon the detection of the adverse space charge effect, the controller 193 can be employed to adjust the frequency of the RF signal and/or its voltage amplitude so as to reduce, and preferably eliminate, the detected adverse space charge effect. In some embodiments, such adjustment of the RF frequency and/or RF voltage amplitude can be performed in multiple stages, where after each stage, the intensity of the ion detection signal can be monitored as a function of ion flux to ensure that the change in the RF frequency and/or RF voltage amplitude has resulted in amelioration of the detected space charge effect. This process can be iterated until a desired reduction in the detected space charge effect is achieved.

FIG. 4B shows another configuration of the upstream section according to the present teachings. In the upstream section 16′ shown in FIG. 4B, yet another ion guide (e.g., upstream ion guide or DJet® ion guide) 1051 can be positioned upstream of the above-described ion guide (e.g., QJet® ion guide) 106, within an upstream evacuated chamber 1053. By way of example, the ion guides 1051 and 106 can be positioned in evacuated chambers 1053 and 121 where the upstream evacuated chamber 1053 in which the upstream ion guide 1051 is positioned is maintained at a pressure greater than a pressure at which the ion guide 106 is maintained. For example, the pressure of the upstream evacuated chamber 1053 in which the upstream ion guide 1051 is positioned can be in the 4-6 Torr range while the pressure of the evacuated chamber 121 in which the ion guide 106 is maintained can be in the 2-3 Torr range. As described above, the pressure of the downstream evacuated chamber 122 in which the downstream ion guide 108 is maintained can be in the 2-20 mTorr range.

In some such embodiments, the upstream ion guide 1051 can be utilized to adjust the ion flux, for example, by changing RF voltages applied on the upstream ion guide 1051.

In some embodiments, instead of or in addition to adjusting the RF frequency and/or the RF voltage amplitude, the ion flux entering the mass spectrometer via its inlet can be adjusted to reduce, and preferably eliminate, the adverse space charge effects. For example, in some embodiments, it may not be feasible to provide sufficient adjustment of the RF frequency and/or RF voltage amplitude to obtain a desired reduction of the adverse space charge effects. In some such embodiments, it may be feasible to reduce the ion flux entering the mass spectrometer for dealing with a detected adverse space charge effect. By way of example, the ionization voltage employed in the ion source can be adjusted, e.g., reduced, to lower the ion flux entering the mass spectrometer, thereby reducing and potentially eliminating the detected adverse space charge effects.

### Experiments

In order to assess the occurrence of adverse space charge effects when an ion beam population reaches the threshold at which the transmission of ions with larger m/z ratios decreases due to the Coulomb interaction with ions having lower m/z ratios, experiments were conducted by varying the ion source voltages, the QJet® RF frequencies and amplitudes when operating a Sciex QTOF X500B research grade mass spectrometer, as well as the sample concentration.

FIGS. 5A-5D show the ion transmission performance when the QJet® was operating at a high RF frequency (i.e., 1.6 MHZ), and QJet® RF voltage was set at 300 V. More specifically, FIG. 5A depicts the total ion chromatogram as the ion source voltage is reduced from 5500 V to 3000 V over a time span of about 6 minutes. It can be seen that the total ion chromatogram signal gradually decreases as the ion source voltage is reduced from 5500 V to 3000 V. FIG. 5B shows the Time-of-Flight (ToF) mass spectrum from about minute 0.2 to about minute 0.3, when the ion source voltage was 5500 V.

Referring to FIG. 5C, which shows the XIC (extracting ion count) of ions having a relatively large m/z ratio of 1246, the XIC increases even though the ion source voltage is decreased from 5500 V to about 4500 V (i.e., up to about first 2.5 minutes) and the total ion chromatogram decreases in accordance with the decreasing ion source voltage. The increase of the XIC indicates that the adverse space charge effects occur due to a high ion beam intensity when the ion source voltage is above about 4500 V. Between about 4500 V and 3000 V (i.e. after about 2.5 minutes), the XIC decreases as the total ion chromatogram decreases, as expected. FIG. 5C indicates that at the RF frequency of 1.6 MHz, the ion source voltage should be reduced (e.g., below about 4500 V) to alleviate the adverse space charge effects for the ions having m/z of 1246.

FIG. 5D shows the XIC of ions having a relatively small m/z of 367, and it shows that the XIC of these ions generally decreases as the ion source voltage is decreased from 5500 V to 3000 V, indicating that the space charge effects are less pronounced for the ions with smaller m/z ratios, compared to the ions with larger m/z ratios.

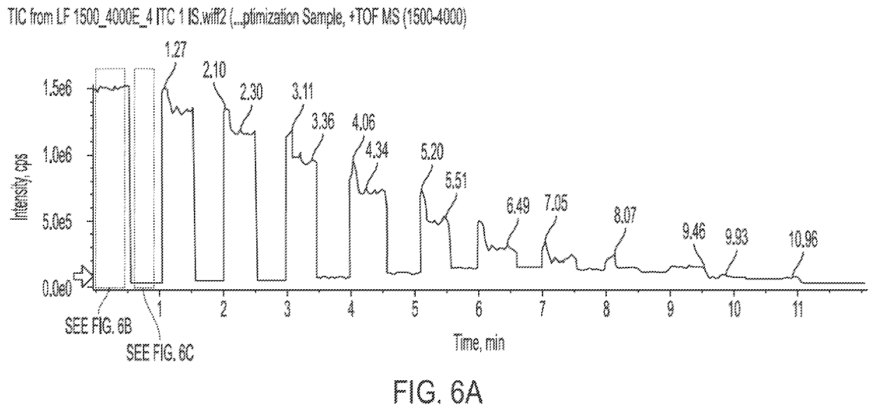

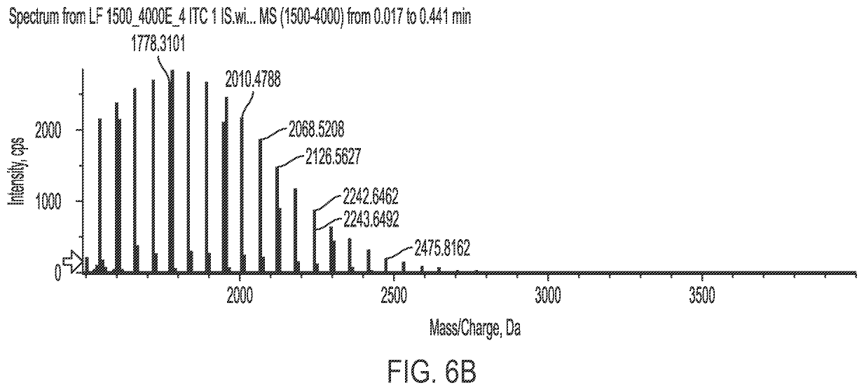

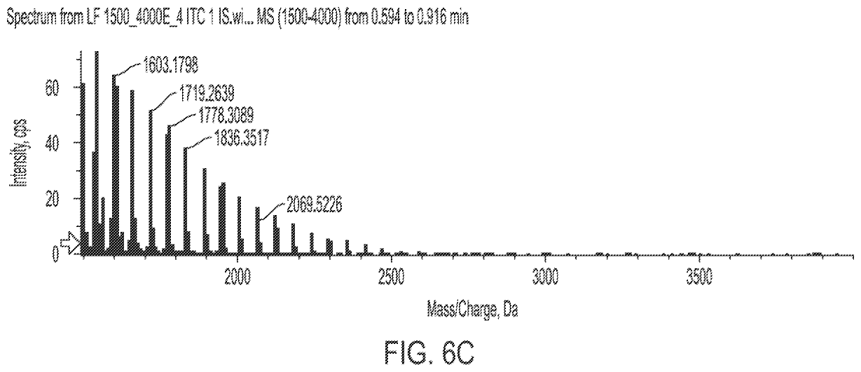

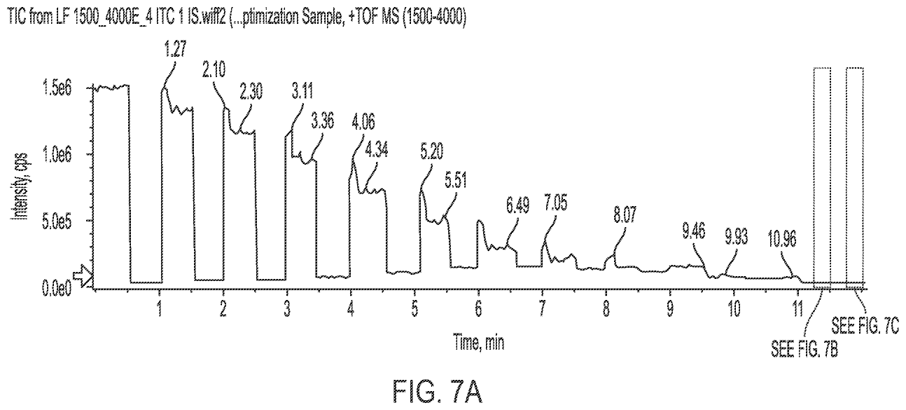

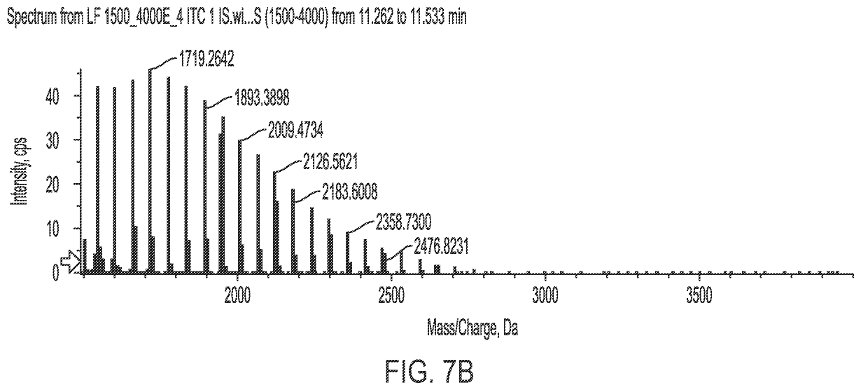

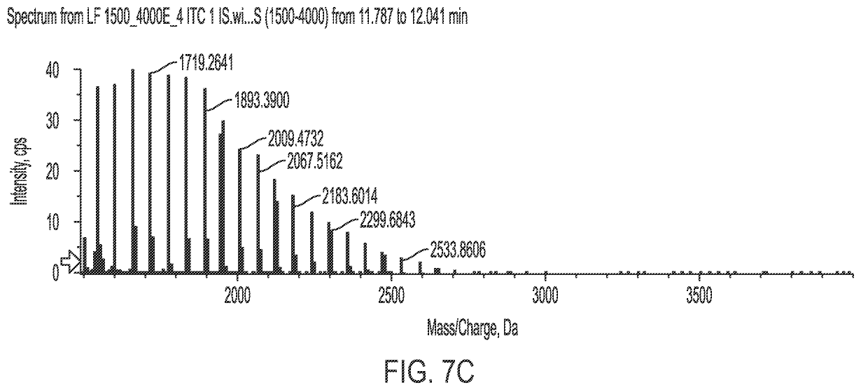

FIGS. 6A-6C and 7A-7C show the ion transmission performance when the QJet® is operating at a low RF frequency (i.e., 0.5 MHz).

FIG. 6A depicts the total ion chromatogram as the ion source voltage is decreased from 5500 V to 3000 V over a time span of about 12 minutes in steps of 250 V. During the 12minutes, the RF voltage was alternated between 300 V and 100 V at an interval of about 30seconds, which is indicated in FIG. 6A by the dips appearing at the second half of each minute. FIG. 6B shows the ToF mass spectrum for about first 0.4 minutes, when the RF voltage was 300 V. FIG. 6C shows the ToF mass spectrum from about minute 0.6 to about minute 0.9, when the RF voltage was 100 V. It can be seen that the ion transmission of m/z>300 is significantly higher when the RF voltage was 300 V, compared to 100 V. This behavior indicates that the QJet® ion population at the ion source voltage of 5500 V is large enough to cause an adverse space charge effects even with low (i.e., 0.5 MHZ) RF frequency and normal operating voltage.

Referring to FIG. 7A, the mass spectrum data for FIG. 7B were taken from about minute 11.3 to about minute 11.5, when the RF voltage was 300 V, and the mass spectrum data for FIG. 7C were taken from about minute 11.8 to about minute 12, when the RF voltage was 100 V. Comparing FIGS. 7B and 7C, no significant difference can be observed in the ion transmission of m/z>300 when the RF voltage increased from 100 V to 300 V, indicating no significant adverse space charge effects at these operating conditions, e.g., IS 3000 V.

Depending on certain implementation requirements, embodiments of the invention can be implemented in hardware and/or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Those having ordinary skill will appreciate that various changes can be made to the above embodiments without departing from the scope of the invention.

What is claimed is:

1. A method of performing mass spectrometry, comprising:
introducing a plurality of ions into an ion guide of a mass spectrometer via an inlet orifice thereof, wherein said ion guide comprises a plurality of rods arranged in a multipole configuration and spaced from one another to provide a passageway for transit of the ions therethrough,
applying RF voltages to said rods so as to generate an electromagnetic field within said passageway for providing radial confinement of the ions passing through the passageway,
identifying an adverse space charge effect based on detection of a variation of an intensity of an ion detection signal associated with at least one ion population transmitted through said ion guide and having an m/z ratio greater than a threshold, and
in response to said identification of the adverse space charge effect, adjusting at least one of frequency of said RF voltages and amplitude of said RF voltages to counteract said space charge effect.

2. The method of claim 1, wherein said step of identifying the space charge effect comprises adjusting an ion flux into said inlet orifice associated with said at least one ion having said m/z ratio above the threshold and identifying said adverse space charge effect based on observing a change indicative of said space charge effect in the intensity of said at least one ion detection signal at two or more ion fluxes.

3. The method of claim 2, wherein said change in said at least one ion detection signal indicative of said adverse space charge effect corresponds to a decrease in the intensity of the ion detection signal in response to an increase in the ion flux or corresponds to an increase in the intensity of the ion detection signal in response to a decrease in the ion flux.

4. The method of claim 1, wherein the step of identifying the adverse space charge effect comprises comparing said intensity of the ion detection signal with an expected intensity for said ion detection signal.

5. The method of claim 2, wherein the step of adjusting the ion flux comprises changing one or both of a concentration of at least one ingredient in a sample ionized and an ionization voltage utilized to generate said plurality of ions.

6. The method of claim 1, wherein the step of identifying the space charge effect comprises comparing the intensity of the ion detection signal associated with the ion having an m/z ratio greater than the threshold with an intensity of an ion detection signal associated with an ion population having an m/z ratio less than the threshold.

7. The method of claim 1, wherein said threshold is about 1 kDa.

8. The method of claim 1, wherein the step of adjusting the at least one of frequency of said RF voltages and amplitude of said RF voltages comprises one or both of reducing the frequency of said RF voltages and increasing the amplitude of said RF voltages.

9. The method of claim 1, wherein said ion guide is positioned in an evacuated chamber maintained at a pressure in a range of about 2 Torr to about 4 Torr.

10. The method of claim 9, further comprising transmitting said plurality of ions through an upstream ion guide positioned upstream of said ion guide and positioned in an upstream evacuated chamber that is maintained at a pressure greater than the pressure of said evacuated chamber.

11. The method of claim 10, wherein said upstream evacuated chamber is maintained at the pressure in a range of about 4 Torr to about 6 Torr.

12. The method of claim 9, further comprising transmitting said plurality of ions through a downstream ion guide positioned downstream of said ion guide and positioned in a downstream evacuated chamber that is maintained at a pressure lower than the pressure of said evacuated chamber.

13. The method of claim 12, wherein said downstream evacuated chamber is maintained at the pressure in a range of about 2 mTorr to about 20 mTorr.

14. The method of claim 10, wherein said step of identifying the space charge effect comprises adjusting an ion flux into said inlet orifice associated with said at least one ion having said m/z ratio above the threshold and identifying said adverse space charge effect based on observing a change indicative of said space charge effect in the intensity of said at least one ion detection signal at two or more ion fluxes, and wherein the step of adjusting the ion flux comprises changing an RF voltage applied on said upstream ion guide.

15. A method of performing mass spectrometry, comprising:
introducing a sample into an ion source to cause ionization of at least a portion thereof so as to generate a plurality of ions, wherein at least a portion of said ions have an m/z ratio greater than a threshold,
introducing the plurality of ions into an ion guide of a mass spectrometer via an inlet orifice thereof, wherein said ion guide comprises a plurality of rods arranged in a multipole configuration and spaced from one another to provide a passageway for transit of the ions therethrough,
applying RF voltages at a first an RF frequency and a first an RF voltage amplitude to said rods so as to generate an electromagnetic field within said passageway for providing radial confinement of the ions passing through the passageway,
identifying an adverse space charge effect based on a comparison of an intensity of at least one ion detection signal associated with at least one of said ions having an m/z ratio above the threshold with a reference intensity, and
in response to identification of the adverse space charge effect, adjusting at least one of said RF frequency, said RF voltage amplitude, and a flux of ions introduced into said ion guide so as to counteract said adverse space charge effect.

16. The method of claim 15, wherein the step of adjusting the at least one of said RF frequency and said RF voltage amplitude comprises one or both of reducing said RF frequency and increasing said RF voltage amplitude.

17. The method of any one of claims 15 16 claim 15, wherein said step of adjusting the flux of ions introduced into said ion guide comprises adjusting RF voltages applied to rods of a multipole ion guide positioned upstream of said ion guide.

18. A mass spectrometer, comprising:
an ion source configured to receive a sample and to ionize at least a portion of the sample to generate a plurality of ions,
an ion guide positioned downstream of the ion source, said ion guide comprising a plurality of rods arranged in a multipole configuration and configured for application of RF voltages thereto to provide radial confinement of the ions as the ions pass through the ion guide,
an ion detector positioned downstream of said ion guide and configured to receive the ions transmitted through said ion guide and/or one or more fragments thereof generated downstream of said ion guide and to generate one or more ion detection signals, and
an analysis module in communication with said ion detector and configured to receive said one or more ion detection signals and to determine a transmission rate of the ions having m/z ratios above a threshold through said ion guide,
wherein said analysis module is configured to identify an adverse space charge effect on transmission of the ions having m/z ratios above the threshold through the ion guide based on a comparison of said determined transmission rate with a reference transmission rate.

19. The mass spectrometer of claim 18, further comprising an upstream ion guide positioned upstream of said ion guide.

20. The mass spectrometer of claim 18, further comprising a downstream ion guide positioned downstream of said ion guide.
